(19) United States
(12) Patent Application Publication
(10) Pub. No.: US 2009/0206165 A1
(43) Pub. Date: Aug. 20, 2009

(54) CONTACTLESS CHIP MODULE, CONTACTLESS DEVICE, CONTACTLESS SYSTEM, AND METHOD FOR CONTACTLESS COMMUNICATION

(75) Inventors: Peter Laackmann, Munich (DE); Marcus Janke, Munich (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Neubiberg (DE)

(21) Appl. No.: 12/032,035

(22) Filed: Feb. 15, 2008

(51) Int. Cl. G06K 19/067

(52) U.S. Cl. 235/492

(57) ABSTRACT

A contactless chip module including a power supply, adapted to supply the contactless chip module with power obtained from an electromagnetic field; a first receiver adapted to receive an actively modulated signal; and a second receiver adapted to receive a passively modulated signal contained in the electromagnetic field.

### BACKGROUND OF THE INVENTION

Chip cards are used for many purposes, for example as credit cards, debit cards, money cards or prepaid cards for electronic payment, or for telephony or authentication applications.

### SUMMARY

According to an embodiment, a contactless chip module is provided, including a power supply, adapted to supply the contactless chip module with power obtained from an electromagnetic field; a first receiver adapted to receive an actively modulated signal contained in the electromagnetic field; and a second receiver, adapted to receive a load modulated signal contained in the electromagnetic field.

### BRIEF DESCRIPTION OF THE DRAWINGS

Embodiments are described hereinafter making reference to the appended drawings.

FIG. 1 shows a block diagram of an embodiment of a contactless chip module.

FIG. 2A shows a block diagram of another embodiment of a contactless chip module comprising a cryptographic unit.

FIG. 2B shows a block diagram of a further embodiment of a contactless chip card comprising an initiation unit.

FIG. 3 shows a block diagram of a contactless device comprising a contactless chip module.

FIG. 4 shows an embodiment of a contactless communication system comprising a terminal and two contactless devices.

FIG. 5 shows another embodiment of a contactless communication system comprising a terminal and two contactless devices.

FIG. 6 shows a flow chart of an embodiment of a method for contactless communication.

FIG. 7 shows a flow chart of another embodiment of a method for contactless communication.

FIG. 8 shows a flow chart of a further embodiment of a method for contactless communication.

Equal or equivalent elements of equal or equivalent functionality are denoted in the following description of the figures by equal or equivalent reference numerals.

### DETAILED DESCRIPTION OF THE INVENTION

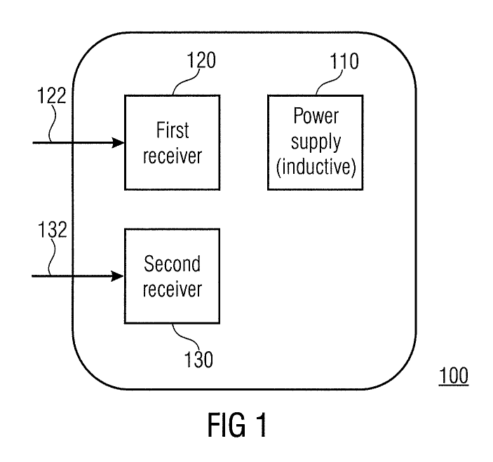

FIG. 1 shows a block diagram of an embodiment of a contactless chip module 100 comprising a power supply 110, a first receiver 120 and a second receiver 130. The power supply 120 is adapted to supply the contactless chip module with power obtained from an electromagnetic field. This can, e.g. be based on inductive coupling or backscatter coupling, as will be explained later in more detail.

In case the power is obtained from the electromagnetic field in an inductive manner, this power supply is also referred to as inductive power supply.

The first receiver 120 is adapted to receive an actively modulated signal 122, for example, the signal generating the electromagnetic field. The second receiver 130 is adapted to receive a passively modulated signal contained in the electromagnetic field, e.g. imposed on the signal generating the electromagnetic field.

The terms “active modulation” and “passive modulation” will be discussed in more detail later.

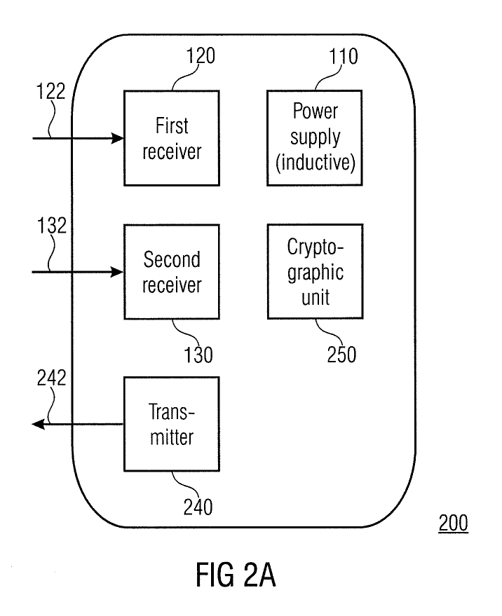

FIG. 2A shows a block diagram of a further embodiment of a contactless chip card 200 comprising the power supply 110, the first receiver 120, the second receiver 130 and additionally a transmitter 240 and a cryptographic unit 250. The transmitter 240 is adapted to passively modulate the electromagnetic field to transmit a passively modulated signal 242 contained in the electromagnetic field, e.g. imposed on the signal generating the electromagnetic field.

The cryptographic unit 250 is adapted to perform an authentication based on the passively modulated signal 132 received via the second receiver 130. The authentication can, for example, be performed to authenticate another contactless chip module having generated the passively modulated signal 132 received via the second receiver 130.

In a further embodiment the cryptographic unit 250 is additionally adapted to perform an authentication based on other signals, e.g. on an actively modulated signal.

The communication between the contactless device 100, 200 can for example, be initiated by another contactless device or a contactless terminal.

FIG. 2B shows a block diagram of a further embodiment of a contactless chip module 200′ comprising additionally to the embodiment shown in FIG. 2A, an initiation unit.

The initiation unit 260 is adapted to initiate autonomously a communication with other contactless devices or terminals by controlling the transmitter to transmit a passively modulated signal, e.g. an initiation signal.

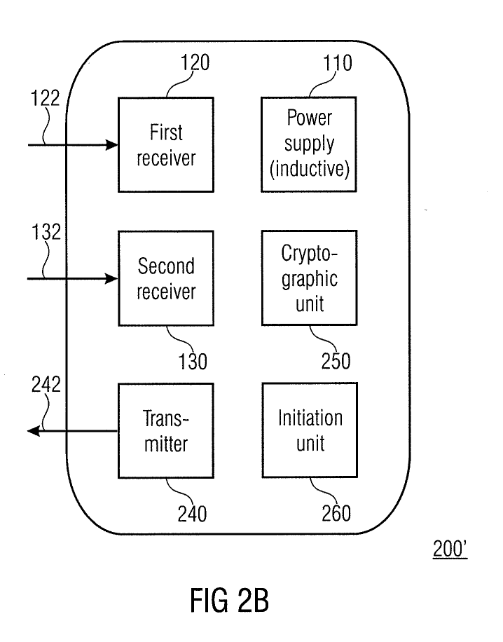

FIG. 3 shows a block diagram of an embodiment of a contactless device comprising a contactless chip module 200 and an antenna 310. The antenna 310 is connected to the power supply 110, the first receiver 120, the second receiver 130, and the transmitter 240. Alternative embodiments of the contactless device 310 comprise other embodiments of the contactless chip module, for example, chip modules 100 or 200′ as shown in FIGS. 1 and 2B.

The first receiver 120 is implemented to receive an actively modulated signal 122 via the antenna 310. The second receiver 130 is implemented to receive a passively modulated signal 132 via the antenna 310 and the transmitter 240 is adapted to passively modulate the electromagnetic field in order to transmit a passively modulated signal 242 via the antenna 310.

The contactless devices can, for example, be contactless chip cards for a variety of applications like credit cards, debit cards, money cards, prepaid cards, microprocessor cards, and/or for authentication and/or data encryption.

Chip cards can be divided into contact-based chip cards, where the chip cards are brought into contact, e.g. inserted into a slot of a terminal, for supplying power to the chip card and for communication with the chip card. Contactless chip cards on the other hand, as the name already suggests, do not need to be brought into physical contact with the terminal, but are typically powered by an electromagnetic field generated by a terminal and communicate with the terminal by radio frequency communication.

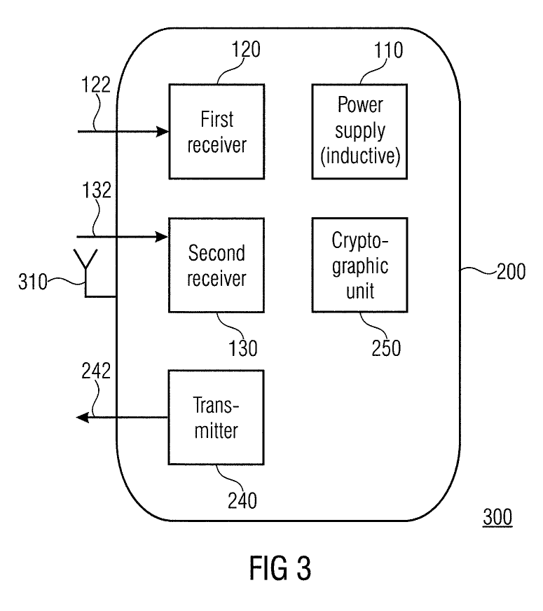

FIG. 4 shows an embodiment of a contactless communication system 4000 comprising a contactless terminal 4600, a first contactless device 4700, and a second contactless device 4100. The contactless terminal 4600 comprises a receiver (Rx) 4630, a transmitter (Tx) 4670 and an antenna 4680.

The contactless terminal 4600 is adapted to generate an electromagnetic field 4900 “surrounding” the first contactless device 4700 and the second contactless device 4800. Embodiments of the contactless terminal 460 can be adapted, e.g. to generate the electromagnetic field 4900 by generating or transmitting an actively modulated signal 4672 via the antenna 4680. The receiver 4630 is adapted to receive a signal 4632 contained in the electromagnetic field 4900 via the antenna 4680. The received signal 4632 can, for example, be a passively modulated signal, for example a load modulated signal.

The first contactless device 4700 comprises a power supply (PS) 110, a transmitter (Tx) 240 and an antenna 310. The transmitter 240 is adapted to passively modulate the electromagnetic field in order to transmit a passively modulated signal 242 via the antenna 310.

The second contactless device 4100 comprises a power supply 110, a receiver 130, and an antenna 310. The receiver 130 of the second contactless device 4100 is adapted to receive a signal 132 via the antenna 310, e.g. the signal 242.

Embodiments of contactless communication systems 4000 as shown in FIG. 4 enable a direct communication from the first contactless device 4700 to the second contactless device 4100, although both contactless devices 4100,4700 receive their power from the electromagnetic field 4900 generated by the terminal 4600. For the communication, for example, a passive modulation scheme can be used.

Within the context of this document, the term “active modulation” is used when referring to generating or transmitting modulated signals using active components like amplifiers, or at least one active component. Modulation schemes for active modulation can be any analog modulation scheme like amplitude modulation (AM), frequency modulation (FM) or phase modulation (PM), or digital modulation schemes like amplitude shift keying (ASK), frequency shift keying (FSK), or phase shift keying (PSK).

In contrast thereto, within the context of this document the term “passive modulation” is used when referring to generating or transmitting modulated signals using passive components, and in particular, when using only passive components.

Another way to distinguish “active modulation” from “passive modulation” is the fact that when transmitting an actively modulated signal, an electromagnetic field is generated, whereas when transmitting a passively modulated signal, an existing electromagnetic field is modified but not generated.

Two known concepts for passively modulation and power supply via an electromagnetic field are “inductive coupling” and “backscatter coupling”.

Embodiments of a contactless device 4700, 4100, based on inductive coupling comprise, for example, a large area coil as antenna 310. As explained before, all the energy needed for the operation of the contactless device is provided by the terminal 4600 via the electromagnetic field. For this purpose, the antenna 4680 of the terminal generates a strong high-frequency electromagnetic field 4900, which penetrates the cross-section of the coil area of the antenna 310 and the area around the coil 310 of the contactless device 4700, 4100. Because the wavelength of the frequency range used is typically several times greater than the distance between the antenna 4680 of the terminal 4600 and contactless device 4700, 4100, the electromagnetic field 4900 can be treated as a simple magnetic alternating field with regard to the distance between terminal 4600 and a contactless device 4700, 4100. A part of the emitted or generated field penetrates the antenna coil 310 of the contactless device. By electromagnetic induction, or short “induction”, a voltage is generated at the antenna 310, which is rectified by the power supply 110 enabling the power supply 110 to supply the power for the contactless device 4700, e.g. to supply the required voltage and current levels. In typical embodiments, a capacitor is connected in parallel with the antenna coil of the contactless device to form a parallel resonant circuit. The resonant frequency is matched to the transmission frequency of the terminal. Thus, high currents can be generated in the antenna coil 310 of the contactless device, due to the resonance step-up in the parallel resonant circuit. This can be used to generate the required field strengths for the operation of the contactless device 4700, 4100.

If such a contactless device, whose resonant frequency corresponds to the transmission frequency of the terminal, is placed within the magnetic alternating field 4900 of the terminal 4600, energy from the electromagnetic field 4900 is drawn. This additional power consumption can be measured as a voltage drop at the internal resistance at the terminal's antenna 4680 through the supply current to the terminal's antenna 4680. The switching on and off of a load resistance at the antenna 310 of the contactless device therefore affects voltage changes at the antenna 4680 at the terminal, and thus has the effect of an amplitude modulation of the antenna voltage by the contactless device 4700. If the switching (on and off) of the load resistor is controlled by data, then this corresponds to a data transmission from the contactless device 4700. This type of data transfer is called “load modulation”. Such load modulated signal 242 can, for example, be received by the receiver 4632 of the terminal, or from the receiver 130 of the second terminal 4100.

To receive or demodulate the load modulated signal 242, embodiments of the receiver 130, 4630 are adapted to rectify the voltage measured at the antenna coil 310. This represents the demodulation, for example, of the thus amplitude modulated signal.

For the inductive coupling, embodiments of the terminal 4600 and the contactless device 4100, 4700, comprise typically antenna coils as antennas 4632, respectively, 310.

An alternative method for passively modulating and transmitting signals is based on “backscatter coupling”. For backscatter coupling, the terminal 4600 and the contactless devices 4100, 4700, typically comprise dipole-antennas as antenna 4632 respectively 310.

The backscattering is based on the fact that electromagnetic waves are reflected by objects with dimensions greater than around half the wavelength of the wave. The efficiency with which an object reflects electromagnetic waves is described by its reflection cross-section. Objects that are in resonance with the wave front that hits them, as is the case for antennas at the appropriate frequency, for example, have a particularly large reflection cross-section.

Power is emitted via the electromagnetic field 4900 to the antenna 310 of the contactless devices 4700, 4100. Part of the power is received at the antenna 310 as high-frequency voltage and after rectification by the power supply 110, the required power can be supplied from the power supply 110 to operate the contactless device 4100, 4700. A proportion of the incoming or received power is reflected by the antenna 310 and returned as reflected power.

The reflection characteristics of the antenna 310 can be influenced by altering a load connected to the load 310. In order to transmit data from the contactless device 4700, a load resistor connected in parallel with the antenna 310 is switched on and off, depending on the datastream to be transmitted. The amplitude of the reflected power from the contactless device can thus be modulated. Therefore, this modulation scheme is also referred to as backscatter modulation.

This reflected signal or backscatter modulated signal can be received, for example by the receiver 4632 of the terminal 4600 or by the receiver 130 of the contactless device 4100.

In a specific embodiment according to FIG. 4, the terminal 4600 or any other device is only required for generating an electromagnetic field 4900 to supply power to the contactless devices 4100, 4700 and, in other words, to provide an electromagnetic field onto which the passively modulated signal can be imposed on. The communication is only performed between the two contactless devices 4100, 4700 based on a passive modulation scheme.

In other embodiments, the terminal 4600 can be adapted to, for example, transmit actively modulated signals 4672 to one or all of the contactless devices, and to receive passively modulated signals from one or all of the contactless devices.

As the passively modulated signals are imposed onto the electromagnetic field or, in other words, onto an actively modulated signal, the power level of the passively modulated signal is typically about a factor of 5 to 30 smaller than the power level of the actively modulated signals.

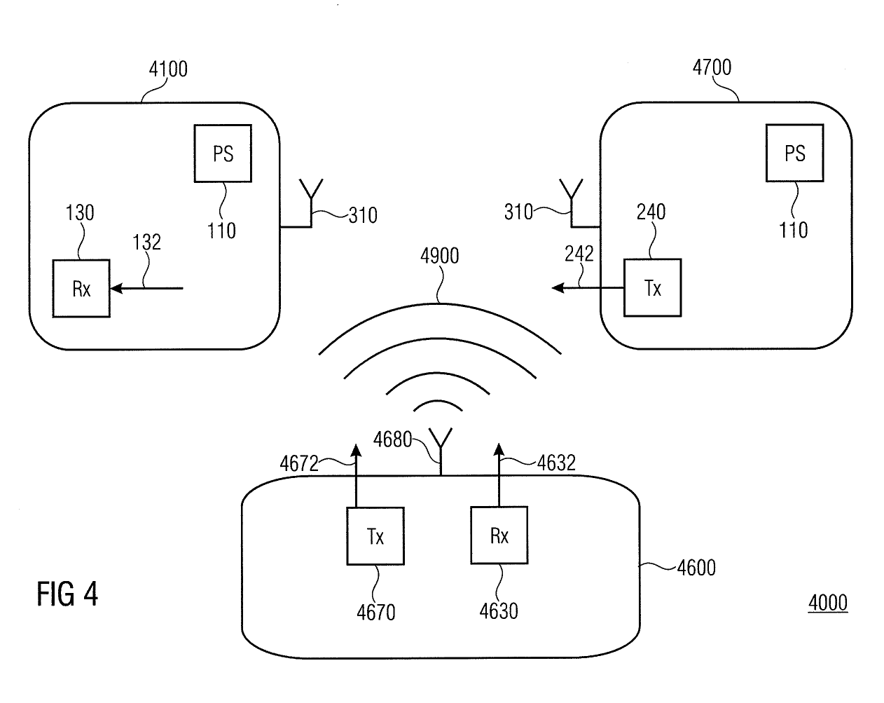

FIG. 5 shows another embodiment of a contactless communication system 5000 comprising a terminal 4600, a first contactless device 5700, and a second contactless device 5100.

The first contactless device 5700 comprises a power supply 110, a first receiver 120, a transmitter 240, and a cryptographic unit (CRYPTO) 250.

The second contactless device 5100 comprises a power supply 110, a first receiver 120, a second receiver 130, a transmitter 240, and a cryptographic unit 250.

The cryptographic unit 250 can be implemented to perform authentication and/or encryption of data transmissions.

According to the scenario, both contactless devices 5700 and 5100 are capable of communicating with the terminal by receiving actively modulated signals 4672, 122 via the antenna 310 at the first receiver 120, and by passively modulating the electromagnetic field in order to transmit passively modulated signals 242, 4632 from their transmitter 240 via the antenna 310.

Furthermore, as already described, based on FIG. 4, the second contactless device 5100 is capable of receiving passively modulated signals 132, 242 from the second terminal 5700. In further embodiments, the first contactless device 5700 can encrypt the data before transmitting the data as passively modulated signal 242, and the second contactless device 5100 can be adapted to decrypt the received passively modulated signal 132, 242. In further embodiments, the cryptographic unit 250 can be used for authentication procedures between both contactless devices 5100, 5700, as will be explained in the following.

In certain applications it is desirable to limit the communication between contactless devices to contactless devices belonging to a specific group. In payment applications it is desirable to limit transactions to trustworthy cards or contactless devices. In these cases, an authentication is performed to authenticate or verify the identity of the other contactless device. This can, for example be done, based on digital signatures.

In the following an embodiment for authentication based on a digital signature or digital signature scheme is described, where the second contactless device 5100 authenticates the first contactless device 5700.

The second contactless device 5100 generates a random number for the authentication and transmits this random number as passively modulated signal 242 to the terminal 4600, which in turn forwards or relays this random number as actively modulated signal 4672 to the first contactless device 5700. The cryptographic unit 250 of the first contactless device 5700 performs, for example, a signing algorithm based on the random number to generate a signature, also referred to as digital signature, and transmits the digital signature as passively modulated signal 242 to the second contactless device 5100. The cryptographic unit 250 of the second contactless device 5100 on the other hand performs a signature verifying algorithm based on the received signature to verify or authenticate the signature of the first contactless device. This verification can, e.g. be performed by comparing the received signature with an expected signature, which is generated by the second contactless device based on the random number. Other authentication procedures based on digital signature or other concepts can also be used. In case of a negative result or authentication, the second contactless device 5100 can, for example, be implemented to not continue the communication with the first contactless device 5700 or deny a payment transaction between the first and second contactless device. In certain embodiments the authentication procedure can be repeated. In case of a positive authentication, the second contactless device 5100 can be implemented, for example to continue the communication with the first contactless device, or, for example, to perform a payment transaction between the first and second contactless device.

In further embodiments, the first contactless device 5700 can be implemented to perform an authentication, for example in a similar manner, by generating a random number and transmitting the latter as passively modulated signal to the terminal 4600, which relays the random number as actively modulated signal to the second contactless device 5100. In this case, the second contactless device 5100 performs the key generation algorithm on the received random number and transmits the result, the digital signature, as passively modulated signal to the terminal, which relays the digital signature as actively modulated signal to the first contactless device 5700. The first contactless device 5700 performs the signature verifying algorithm/procedure to decide whether it accepts the second contactless device or rejects it.

In further embodiments, both, the first contactless device 5700 and second contactless device 5100, can be implemented to authenticate the other contactless device.

In still further embodiments, the first contactless device 5700 is implemented to comprise, like the second contactless device 5100, a second receiver 130. In such embodiments, a direct two-way communication of the two contactless devices 5100, 5700 via passively modulated signals is possible, not requiring the terminal 4600 for relaying any information.

In payment or payment transaction applications based on chip cards, often two types of cards are employed: cards for “customers” enabling them to purchase something electronically (also referred to as customer cards) and cards for the merchants or seller, also referred to as merchant cards. To reduce the risk of fraud, in such payment solutions, an authentication of at least the customer card is performed before the transaction, for example before a money transfer from one bank account to another bank account is accepted and/or a good is handed over. In so-called online systems, such authentication of the customer card and the merchant card are performed by a third entity, also referred to as authentication server. The authentication server performs the authentication with each card, the customer card and the merchant card, individually. In so-called offline systems the authentication of the customer card is performed by the merchant card, which can be further implemented to also store the amount of the transaction and further data about the transaction, e.g. the customer card number.

In payment applications using, for example, embodiments of the contactless devices as money cards, the first contactless device 4700, 5700 can be a customer card and the second contactless device 4100, 5100 can be a merchant card.

For example, if a customer using the customer card wishes to purchase an item from a merchant or a vending machine, the merchant card performs, before allowing the transaction of providing the goods in return to the payment, an authentication of the customer card, to avoid fraud. This authentication can be performed, for example, based on a digital signal as described before. Any other authentication scheme is also possible. In case of a positive authentication, the merchant card will accept the transaction, the goods purchased will be provided and in return digital money will be transferred, e.g. by transmitting a passively modulated signal from the customer card to the merchant card.

In further embodiments, the contactless device 5100, 5700 may be any of the embodiments described based on FIGS. 1 to 3.

Other embodiments of the contactless device may comprise a button for initializing a communication or an authentication via the initiation unit 260 as shown in FIG. 2B. In further embodiments, the contactless device may comprise a display and a keyboard as user interface.

In still further embodiments, the contactless device can be a handheld terminal comprising an initialization button or any other user interface and additionally a slot for inserting a chip card according to one of the embodiments described based on FIGS. 1 to 3. This handheld terminal has, e.g. no own power supply, or at least has no own active power supply like batteries, or is adapted to supply power to the contactless device. Thus, in other words, the handheld terminal and the contactless chip card according to one of the embodiments described based on FIGS. 1 to 3 form another embodiment of a contactless device.

Thus, for example a transaction between a merchant card and a customer card is possible, without requiring a contactless terminal for initiating the transaction.

Thus, furthermore, for example a transaction between a merchant card and a customer card is possible, without requiring a contactless terminal for authenticating the two cards.

And thus, for example a direct contactless transaction between a merchant card and a customer card is possible, without requiring a terminal for relaying the information. The electromagnetic field used for the power supply and for the passively modulation can be generated by the terminal or any other device.

In another embodiment of a contactless communication system, a cashier, for example, at the point of sale in a supermarket carries a contactless device, for example, a contactless chip card, and the payment of customers is performed—at least partially—by contactless money or credit cards. In such an embodiment for example the check-out forms a terminal 4600, 5600 and transmits a transaction request to pay the amount due as an actively modulated signal. The customer having a customer card—forming the first contactless device 4700, 5700—confirms the payment using his customer card, and the transaction is processed. The cashier has additionally a contactless device forming the second contactless device 4100, 510, which is in addition to the terminal 4600, capable of receiving the passively modulated signal from the customer card and to store the transactions. Thus, e.g. at the end of a shift, the contactless transactions from the cashier can be downloaded from his personal contactless chip card for further analysis and reports.

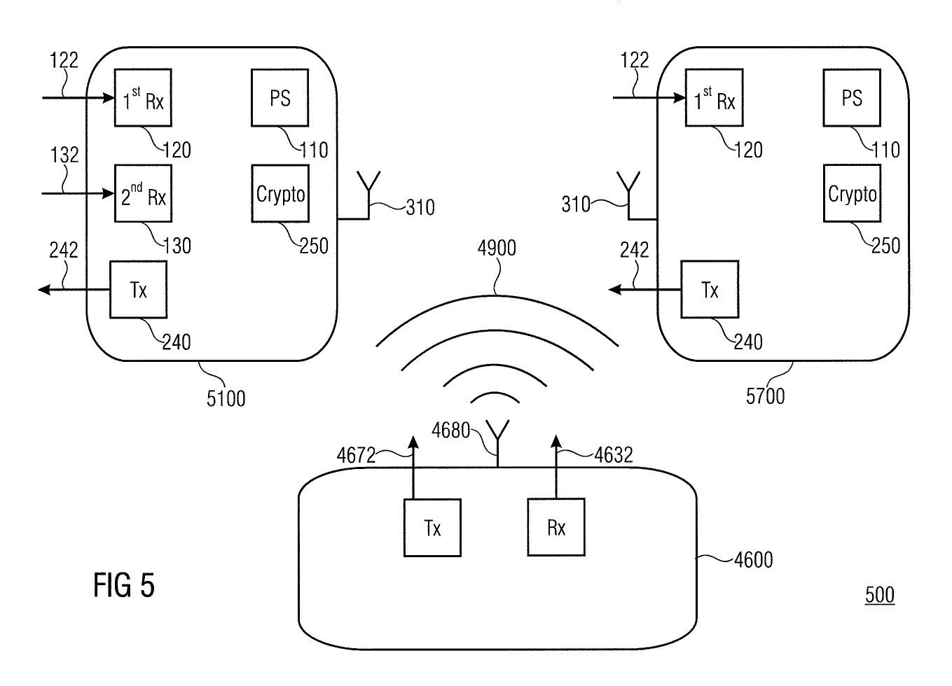

FIG. 6 shows a flowchart of an embodiment of a method for a contactless communication 600 using two contactless devices, wherein each of the contactless devices comprises a power supply adapted to supply the contactless device with power obtained from an electromagnetic field surrounding the contactless device. The method comprises the following steps.

In step 610, a first contactless device transmits a signal.

In step 620, the second contactless device receives the signal transmitted from the first contactless device.

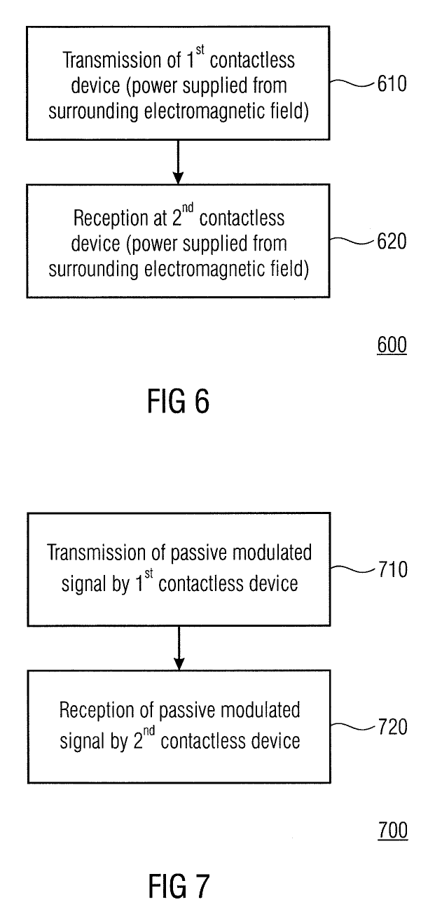

FIG. 7 shows a flowchart of another embodiment of a method for a contactless communication 700 using a first and a second contactless device, each comprising a power supply adapted to supply the contactless device with power obtained from an electromagnetic field surrounding the electromagnetic device. The method comprises the following steps.

In step 710, a passively modulated signal is transmitted by the first contactless device.

In step 720, the passively modulated signal from the first contactless device is received at the second contactless device.

In a further embodiment, the passive modulation is a load modulation and the power supply is an inductive power supply.

Embodiments of the present invention using passive contactless devices or contactless modules obtaining their power from the electromagnetic field surrounding them and applying passive modulation schemes for the transmission of signals provide means for a very energy efficient or low power data communication.

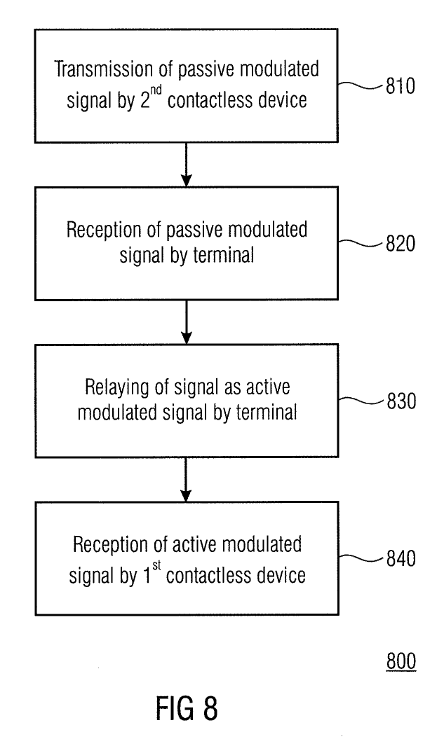

FIG. 8 shows a flow chart of another embodiment of a communication method 800 analog to embodiments described based on FIG. 5. For the method, a first and a second contactless device and a terminal are used. The first and the second contactless device each comprise a power supply adapted to supply the contactless devices with power obtained from an electromagnetic field surrounding the contactless devices.

In step 810, the second contactless device transmits information in a passively modulated manner, i.e., as a passively modulated signal.

In step 820, the terminal receives the passively modulated signal, extracts the information and retransmits or relays in step 830 the information contained in the passively modulated signal in an actively modulated manner, i.e., as an actively modulated signal.

In step 840, the first contactless device receives the actively modulated signal and, thus, the information originally transmitted from the second contactless device.

Thus, FIG. 8 shows an embodiment for an indirect or relayed communication between two contactless devices via a contactless terminal.

Embodiments of the present invention enable an authentication possibility for a contactless data transmission between chip cards to allow the transmission for the cards and/or to secure the data transmission.

In known solutions, the authentication is performed by the terminal. The terminal establishes based on software residing on the terminal individual links to the individual chip cards in the field to perform the authentication individually for each card. This functionality or role can also be referred to as “secure element”.

Embodiments of the contactless modules and contactless devices, for example cards, act in the field as “secure-RF-element”. For a data transmission between two cards in the electromagnetic field, this secure RF-element serves to authenticate the data transmission, for example, by determining a digital signature over the transmitted data.

One embodiment comprises programming a contactless chip card such that this chip card performs the authentication function. In a further embodiment, the secure-RF-element is capable of initiating a communication between two contactless chip cards. Thus, two contactless chip cards can communicate with each other in a radio frequency field (RF), the radio frequency field also being used for power supply, without having to transmit the data via the terminal, the terminal forwarding the data in a transparent manner from one card to the other.

A further application of embodiments of the invention is near field communication. Near field communication, or NFC, is a short-range high frequency wireless communication technology which enables the exchange of data between devices over a short distance, for example about a decimeter distance. The technology is an extension of the ISO 14443 proximity-card standard. An NFC device can communicate with both existing ISO 14443 smartcards and readers, as well as with other NFC devices, and is thereby compatible with existing contactless infrastructure already in use, for example for public transportation and payment. NFC is primarily aimed at usage in mobile phones.

Like ISO 14443, NFC communicates via magnetic field induction, where two loop antennas are located within each others near field, effectively forming an air-core transformer. Two communication modes are specified: passive communication mode and active communication mode. In the passive communication mode, a so-called “initiator device” provides a carrier field and a so-called “target device” answers by modulating the existing field. In this mode, the target device may draw its operating power from the initiator-provided electromagnetic field, thus making the target device a transponder. In the active communication mode, both initiator and target device communicate by alternatively generating their own fields. The device deactivates its radio frequency field while it is waiting for data. In this mode, both devices, initiator and target device, rely on power supplied, for example by batteries or DC current. One use case for near field communication is referred to as “card emulation”, where the NFC device, e.g. the mobile phone, behaves like an existing contactless card. Another use case for near field communication is referred to as “reader mode”, where the NFC device is active and reads, for example, a passive radio frequency identification (RFID) tag, e.g. for interactive advertising. A further use case for near field communication is referred to as “peer-to-peer mode”, where two NFC devices communicate together and exchange information.

Embodiments of the contactless chip module 100, 200, 200′ as described based on FIGS. 1, 2A and 2B can be integrated, e.g. into mobile phones or the like to enable near field communication. Furthermore, the aforementioned contactless chip module or its functionality can be integrated into a SIM card (SIM—subscriber identification module) or the like used in wireless communication. Embodiments of the contactless device 300 as described, e.g. based on FIG. 3, can be implemented as SIM cards or the like with an on-chip antenna 310 or implemented as SIM-cards or the like without on-chip antenna but being connectable to an antenna 310, which is implemented in the mobile phone and connected with the SIM-card when the SIM card is inserted into the mobile phone. Furthermore, the contact less device 300, the first contactless device 4700, 5700 and/or the second contactless device 4100, 5100 may be a mobile phone or the like. As mobile phones are typically powered by batteries, also the contactless chip module integrated in the mobile phone can alternatively be powered by, e.g. the battery or other means instead of receiving its power from the electromagnetic field surrounding the mobile phone. In other words, alternative embodiments of the contactless chip modules may not comprise a power supply adapted to supply the contactless chip module with power obtained from an electromagnetic field surrounding the contactless chip module.

Depending on certain implementation requirements of the inventive methods, the inventive methods can be implemented in hardware or in software. The implementation can be performed using digital storage medium, in particular, a disc, CD or a DVD having an electronically readable control signal stored thereon, which cooperates with a programmable computer system, such that an embodiment of the inventive methods is performed. Generally, an embodiment of the present invention is, therefore, a computer program product with a program code stored on a machine-readable carrier, the program code being operative for performing the inventive methods when the computer program product runs on a computer. In other words, embodiments of the inventive methods are therefore, a computer program having a program code for performing at least one of the inventive methods when a computer program runs on a computer.

The aforegoing has particularly shown and described with reference to the particular embodiments thereof, it will be understood by those skilled in the art that various other changes in the form and details may be made without departing from the spirit and scope thereof. It is therefore to be understood that various changes may be made in adapting to different embodiments without departing from the broader concept disclosed herein and comprehended by the claims that follow.

1. A contactless chip module, comprising:
a power supply adapted to supply the contactless chip module with power obtained from an electromagnetic field;
a first receiver adapted to receive an actively modulated signal contained in the electromagnetic field; and
a second receiver adapted to receive a passively modulated signal contained in the electromagnetic field.

2. The contactless chip module according to claim 1, wherein the power supply is an inductive power supply, adapted to supply the contactless chip module with power obtained from an electromagnetic field in an inductive manner.

3. The contactless chip module according to claim 1, wherein the second receiver is adapted to receive a load modulated signal contained in the electromagnetic field.

4. The contactless chip module according to claim 1, comprising:
a cryptographic unit adapted to perform an authentication based on the passively modulated signal received by the second receiver.

5. The contactless chip module according to claim 4, wherein the cryptographic unit is adapted to perform the authentication to authenticate another contactless chip module.

6. The contactless chip module according to claim 4, wherein the cryptographic unit is adapted to decrypt data contained in a received signal and/or to encrypt data to be transmitted by the contactless chip module.

7. The contactless chip module according to claim 1, comprising:
a transmitter adapted to passively modulate the electromagnetic field in order to transmit a passively modulated signal contained in the electromagnetic field.

8. The contactless chip module according to claim 7, comprising:
an initiation unit, adapted to initiate independent of a received actively modulated or passively modulated signal a communication by controlling the transmitter to transmit a load modulated initiation signal.

9. The contactless chip module according to claim 8, wherein the initiation unit is adapted to initiate a communication with another contactless chip module.

10. A contactless device, comprising:
an antenna;
a contactless chip module comprising:
a power supply adapted to supply the contactless chip module with power obtained from an electromagnetic field;
a first receiver adapted to receive an actively modulated signal contained in the electromagnetic field; and
a second receiver, adapted to receive a passively modulated signal contained in the electromagnetic field.

11. The contactless device according to claim 10, which is a contactless chip card.

12. A contactless communication system, comprising:
a contactless terminal adapted to generate an electromagnetic field;
a first contactless device comprising a power supply adapted to supply the first contactless device with power obtained from the electromagnetic field, and a transmitter adapted to transmit a signal;
a second contactless device, comprising a power supply adapted to supply the second contactless device with power obtained from the electromagnetic field and a receiver adapted to receive the signal transmitted by the first contactless device.

13. The contactless communication system according to claim 12, wherein the transmitter of the first contactless device is adapted to passively modulate the electromagnetic field in order to transmit a passively modulated signal contained in the electromagnetic field, and wherein the receiver of the second contactless device is adapted to receive the passively modulated signal contained in the electromagnetic field.

14. The contactless communication system according to claim 12, wherein the second contactless device comprises a transmitter adapted to passively modulate the electromagnetic field in order to transmit a passively modulated signal contained in the electromagnetic field;
wherein the contactless terminal comprises a receiver, adapted to receive the passively modulated signal from the second contactless device, and further comprises a transmitter to transmit an actively modulated signal contained in the electromagnetic field and to relay information contained in the load modulated signal from the second contactless device in such an actively modulated signal; and
wherein the first contactless device further comprises a receiver adapted to receive the actively modulated signal from the terminal.

15. The contactless communication system according to claim 12, wherein the second contactless device comprises a transmitter, adapted to passively modulate the electromagnetic field in order to transmit a passively modulated signal contained in the electromagnetic field; and
wherein the first contactless device comprises a receiver adapted to receive the passively modulated signal from the second contactless device.

16. A contactless communication method using a first and a second contactless device, wherein each contactless device comprises a power supply adapted to supply the contactless device with power obtained from an electromagnetic field, the method comprising:
transmitting a signal from the first contactless device; and
receiving the signal at the second contactless device.

17. The contactless communication method according to claim 16, wherein the transmission of a signal comprises a modulation of the electromagnetic field in order to transmit a passively modulated signal, and
wherein the reception of the signal is a reception of a passively modulated signal.

18. A contactless communication method using a contactless terminal and a first and a second contactless device, each contactless device comprising a power supply adapted to supply the contactless device with power obtained from an electromagnetic field, the method comprising:
transmitting a passively modulated signal by the second contactless device by means of passively modulating the electromagnetic field;
receiving the passively modulated signal by the contactless terminal;
relaying information contained in the received passively modulated signal by transmitting an actively modulated signal contained in the electromagnetic field; and
receiving the actively modulated signal by the first contactless device.

19. A computer readable medium having stored thereon a computer program having a program code for performing a contactless communication method using a first and a second contactless device, wherein each contactless device comprises a power supply adapted to supply the respective contactless device with power obtained from an electromagnetic field, the method comprising:
transmitting a signal from the first contactless device; and
receiving the signal at the second contactless device.
